(19) United States
(12) Patent Application Publication
(10) Pub. No.: US 2024/0267503 A1
(43) Pub. Date: Aug. 8, 2024

(54) Stereoscopic Foveated Image Generation

(71) Applicant: Apple Inc., Cupertino, CA (US)

(72) Inventors: Yashas Rai Kurlethimar, San Jose, CA (US); Seyedkoosha Mirhosseini, Santa Clara, CA (US); Tobias Eble, Laupheim (DE)

(21) Appl. No.: 18/437,143

(22) Filed: Feb. 8, 2024

Related U.S. Application Data
(60) Provisional application No. 63/444,097, filed on Feb. 8, 2023.

(51) Int. Cl. H04N 13/296; G06T 3/40; G06T 15/00; H04N 13/344

(52) U.S. Cl. CPC H04N 13/296; G06T 3/40; G06T 15/00; H04N 13/344

(57) ABSTRACT

In one implementation, a method of generating an image is performed by a device including one or more processors and non-transitory memory. The method includes generating a first resolution function based on a formula with a set of variables having a first set of values. The method includes generating a first image based on first content and the first resolution function. The method includes detecting a resolution constraint. The method includes generating a second resolution function based on the formula with the set of variables having a second set of values, wherein the second resolution function has a summation value that satisfies the resolution constraint. The method includes generating a second image based on second content and the second resolution function.

### CROSS-REFERENCE TO RELATED APPLICATIONS

This application claims priority to U.S. Provisional Patent App. No. 63/444,097, filed on Feb. 8, 2023, which is hereby incorporated by reference in its entirety.

### TECHNICAL FIELD

The present disclosure generally relates to image generation, and in particular, to systems, methods, and devices for generating images with a varying amount of detail.

### BACKGROUND

Rendering or otherwise processing an image can be computationally expensive. Accordingly, to reduce this computational burden, advantage is taken of the fact that humans typically have relatively weak peripheral vision. Accordingly, different portions of the image are presented on a display panel with different resolutions. For example, in various implementations, portions corresponding to a user's fovea are presented with higher resolution than portions corresponding to a user's periphery.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIG. 2 illustrates an XR pipeline that receives XR content and displays an image on a display panel based on the XR content in accordance with some implementations.

FIGS. 3A-3D illustrate various resolution functions in a first dimension in accordance with various implementations.

FIGS. 4A-4D illustrate various two-dimensional resolution functions in accordance with various implementations.

FIG. 5A illustrates an example resolution function that characterizes a resolution in a display space as a function of angle in a warped space in accordance with some implementations.

FIG. 5B illustrates the integral of the example resolution function of FIG. 5A in accordance with some implementations.

FIG. 5C illustrates the tangent of the inverse of the integral of the example resolution function of FIG. 5A in accordance with some implementations.

FIG. 6A illustrates an example resolution function for performing static foveation in accordance with some implementations.

FIG. 6B illustrates an example resolution function for performing dynamic foveation in accordance with some implementations.

FIG. 7 is a flowchart representation of a method of rendering an image based on a resolution function in accordance with some implementations.

FIG. 8A illustrates an example image representation, in a display space, of XR content to be rendered in accordance with some implementations.

FIG. 8B illustrates a warped image of the XR content of FIG. 8A in accordance with some implementations.

FIG. 9 is a flowchart representation of a method of satisfying a resolution constraint in accordance with some implementations.

FIGS. 10A-10D illustrate example resolution functions for performing monocular and binocular resolution reduction.

FIG. 11 is a flowchart representation of a method of rendering images in accordance with some implementations.

FIG. 12 is a block diagram of an example controller in accordance with some implementations.

FIG. 13 is a block diagram of an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and method for generating an image. In various implementations, the method is performed by a device including a display, one or more processors, and non-transitory memory. The method includes obtaining a first resolution function and a second resolution function, wherein the second resolution function is different than the first resolution function. The method includes generating a first rendered image based on content and the first resolution function and a second rendered image based on the content and the second resolution function. The method includes simultaneously displaying a first displayed image based on the first rendered image on a first portion of the display and a second displayed image based on the second rendered image on a second portion of the display.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

As noted above, in various implementations, different portions of an image are presented on a display panel with different resolutions. However, in various implementations, when a pair of stereoscopic images are presented on a first portion of a display panel and a second portion of a display panel (or two separate display panels) the resolutions at corresponding locations on a first portion of the display panel and a second portion of the display panel may differ.

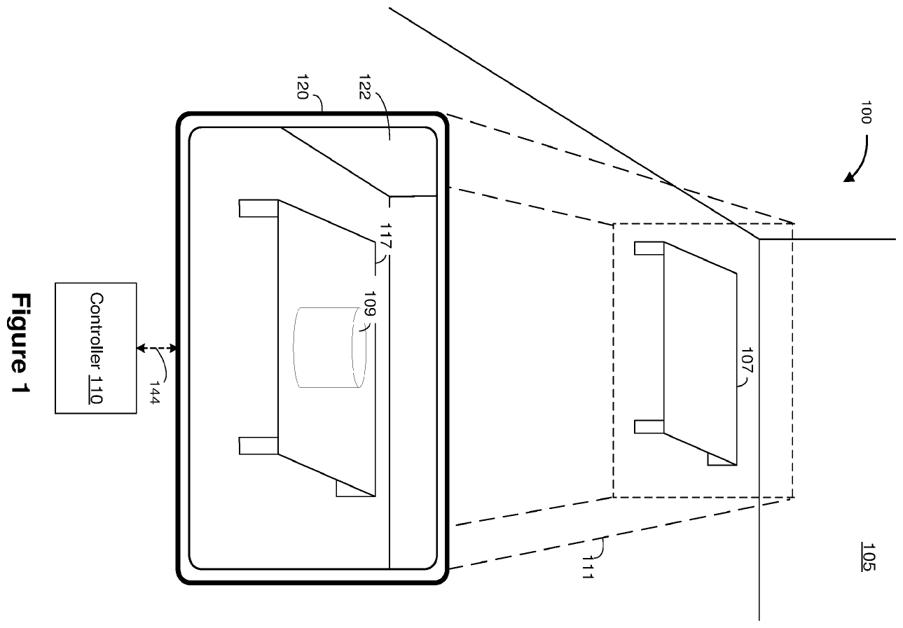

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

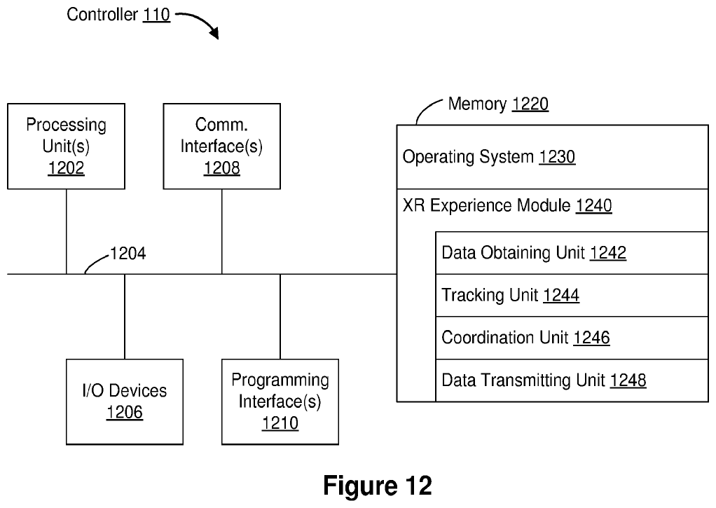

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 12. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

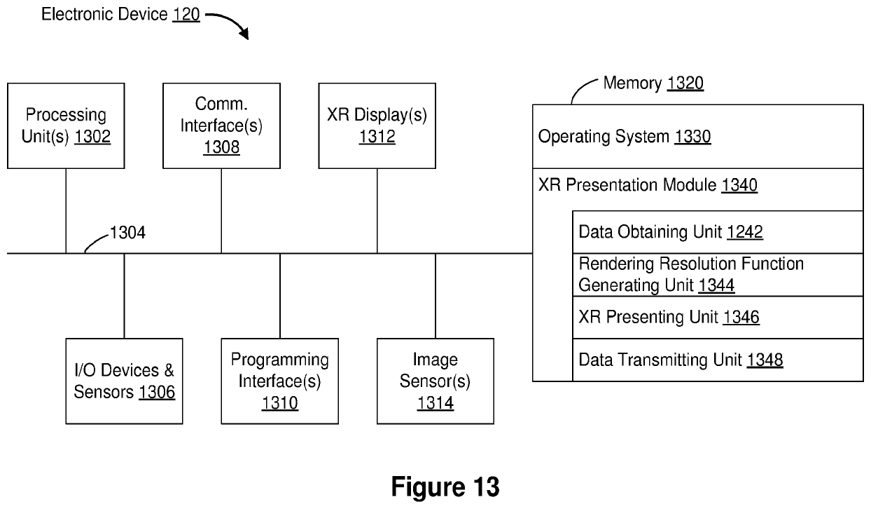

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is physically present within the physical environment 105 that includes a table 107 within the field-of-view 111 of the electronic device 120. As such, in some implementations, the user holds the electronic device 120 in his/her hand(s). In some implementations, while providing XR content, the electronic device 120 is configured to display an XR object (e.g., an XR cylinder 109) and to enable video pass-through of the physical environment 105 (e.g., including a representation 117 of the table 107) on a display 122. The electronic device 120 is described in greater detail below with respect to FIG. 13.

According to some implementations, the electronic device 120 provides an XR experience to the user while the user is virtually and/or physically present within the physical environment 105.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the physical environment 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

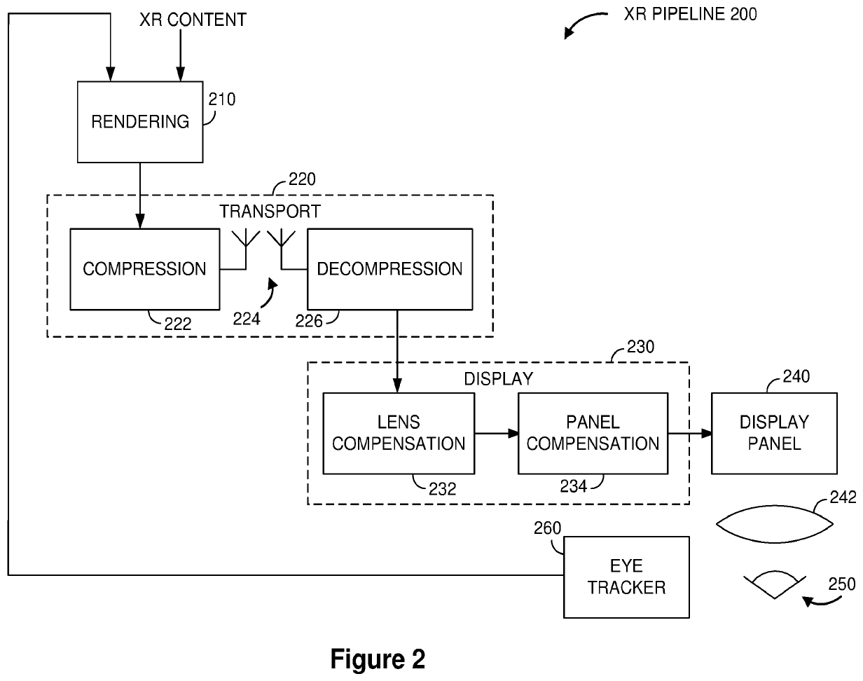

In various implementations, the electronic device 120 includes an XR pipeline that presents the XR content. FIG. 2 illustrates an XR pipeline 200 that receives XR content and displays an image on a display panel 240 based on the XR content.

The XR pipeline 200 includes a rendering module 210 that receives the XR content (and eye tracking data from an eye tracker 260) and renders an image based on the XR content. In various implementations, XR content includes definitions of geometric shapes of virtual objects, colors and/or textures of virtual objects, images (such as a pass-through image of the physical environment), and other information describing content to be represented in the rendered image.

An image includes a matrix of pixels, each pixel having a corresponding pixel value and a corresponding pixel location. In various implementations, the pixel values range from 0 to 255. In various implementations, each pixel value is a color triplet including three values corresponding to three color channels. For example, in one implementation, an image is an RGB image and each pixel value includes a red value, a green value, and a blue value. As another example, in one implementation, an image is a YUV image and each pixel value includes a luminance value and two chroma values. In various implementations, the image is a YUV444 image in which each chroma value is associated with one pixel. In various implementations, the image is a YUV420 image in which each chroma value is associated with a 2×2 block of pixels (e.g., the chroma values are downsampled). In some implementations, an image includes a matrix of tiles, each tile having a corresponding tile location and including a block of pixels with corresponding pixel values. In some implementations, each tile is a 32×32 block of pixels. While specific pixel values, image formats, and tile sizes are provided, it should be appreciated that other values, formats, and tile sizes may be used.

The image rendered by the rendering module 210 (e.g., the rendered image) is provided to a transport module 220 that couples the rendering module 210 to a display module 230. The transport module 220 includes a compression module 222 that compresses the rendered image (resulting in a compressed image), a communications channel 224 that carries the compressed image, and a decompression module 226 that decompresses the compressed image (resulting in a decompressed image).

The decompressed image is provided to a display module 230 that converts the decompressed image into panel data. The panel data is provided to a display panel 240 that displays a displayed image as described by (e.g., according to) the panel data. The display module 230 includes a lens compensation module 232 that compensates for distortion caused by an eyepiece 242 of the electronic device 120. For example, in various implementations, the lens compensation module 232 pre-distorts the decompressed image in an inverse relationship to the distortion caused by the eyepiece 242 such that the displayed image, when viewed through the eyepiece 242 by a user 250, appears undistorted. The display module 230 also includes a panel compensation module 234 that converts image data into panel data to be read by the display panel 240.

The display panel 240 includes a matrix of M×N pixels located at respective locations in a display space. The display panel 240 displays the displayed image by emitting light from each of the pixels as described by (e.g., according to) the panel data.

In various implementations, the XR pipeline 200 includes an eye tracker 260 that generates eye tracking data indicative of a gaze of the user 250. In various implementations, the eye tracking data includes data indicative of a fixation point of the user 250 on the display panel 240. In various implementations, the eye tracking data includes data indicative of a gaze angle of the user 250, such as the angle between the current optical axis of the user 250 and the optical axis when the user 250 is looking at the center of the display panel 240.

In various implementations, in order to render an image for display on the display panel 240, the rendering module 210 generates M×N pixel values for each pixel of an M×N image. Thus, each pixel of the rendered image corresponds to a pixel of the display panel 240 with a corresponding location in the display space. Thus, the rendering module 210 generates a pixel value for M×N pixel locations uniformly spaced in a grid pattern in the display space.

Rendering M×N pixel values can be computationally expensive. Further, as the size of the rendered image increases, so does the amount of processing needed to compress the image at the compression module 222, the amount of bandwidth needed to transport the compressed image across the communications channel 224, and the amount of processing needed to decompress the compressed image at the decompression module 226.

In various implementations, in order to decrease the size of the rendered image without degrading the user experience, foveation (e.g., foveated imaging) is used. Foveation is a digital image processing technique in which the image resolution, or amount of detail, varies across an image. Thus, a foveated image has different resolutions at different parts of the image. Humans typically have relatively weak peripheral vision. According to one model, resolvable resolution for a user is maximum over a fovea (e.g., an area where the user is gazing) and falls off in an inverse linear fashion. Accordingly, in one implementation, the displayed image displayed by the display panel 240 is a foveated image having a maximum resolution at a fovea and a resolution that decreases in an inverse linear fashion in proportion to the distance from the fovea.

Because some portions of the image have a lower resolution, an M×N foveated image includes less information than an M×N unfoveated image. Thus, in various implementations, the rendering module 210 generates, as a rendered image, a foveated image. The rendering module 210 can generate an M×N foveated image more quickly and with less processing power (and battery power) than the rendering module 210 can generate an M×N unfoveated image. Also, an M×N foveated image can be expressed with less data than an M×N unfoveated image. In other words, an M×N foveated image file is smaller in size than an M×N unfoveated image file. In various implementations, compressing an M×N foveated image using various compression techniques results in fewer bits than compressing an M×N unfoveated image.

A foveation ratio, R, can be defined as the amount of information in the M×N unfoveated image divided by the amount of information in the M×N foveated image. In various implementations, the foveation ratio is between 1.5 and 10. For example, in some implementations, the foveation ratio is 2. In some implementations, the foveation ratio is 3 or 4. In some implementations, the foveation ratio is constant among images. In some implementations, the foveation ratio is determined for the image being rendered. For example, in various implementations, the amount of information the XR pipeline 200 is able to throughput within a particular time period, e.g., a frame period of the image, may be limited. For example, in various implementations, the amount of information the rendering module 210 is able to render in a frame period may decrease due to a thermal event (e.g., when processing to compute additional pixel values would cause a processor to overheat). As another example, in various implementations, the amount of information the transport module 220 is able to transport in a frame period may decrease due to a decrease in the signal-to-noise ratio of the communications channel 224.

In some implementations, in order to render an image for display on the display panel 240, the rendering module 210 generates M/R×N/R pixel values for each pixel of an M/R×N/R warped image. Each pixel of the warped image corresponds to an area greater than a pixel of the display panel 240 at a corresponding location in the display space. Thus, the rendering module 210 generates a pixel value for each of M/R×N/R locations in the display space that are not uniformly distributed in a grid pattern. The respective area in the display space corresponding to each pixel value is defined by the corresponding location in the display space (a rendering location) and a scaling factor (or a set of a horizontal scaling factor and a vertical scaling factor).

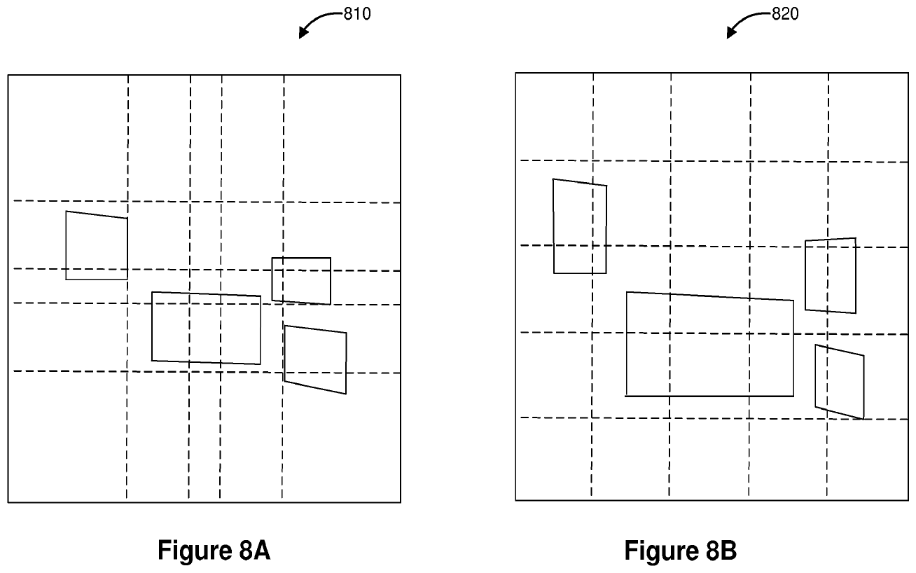

In various implementations, the rendering module 210 generates, as a rendered image, a warped image. In various implementations, the warped image includes a matrix of M/R×N/R pixel values for M/R×N/R locations uniformly spaced in a grid pattern in a warped space that is different than the display space. Particularly, the warped image includes a matrix of M/R×N/R pixel values for M/R×N/R locations in the display space that are not uniformly distributed in a grid pattern. Thus, whereas the resolution of the warped image is uniform in the warped space, the resolution varies in the display space. This is described in greater detail below with respect to FIGS. 8A and 8B.

The rendering module 210 determines the rendering locations and the corresponding scaling factors based on a resolution function that generally characterizes the resolution of the rendered image in the displayed space.

In one implementation, the resolution function, S(x), is a function of a distance from an origin of the display space (which may correspond to the center of the display panel 240). In another implementation, the resolution function, S(θ), is a function of an angle between an optical axis of the user 250 and the optical axis when the user 250 is looking at the center of the display panel 240. Thus, in one implementation, the resolution function, S(θ), is expressed in pixels per degree (PPD).

Humans typically have relatively weak peripheral vision. According to one model, resolvable resolution for a user is maximum over a fovea and falls off in an inverse linear fashion as the angle increases from the optical axis. Accordingly, in one implementation, the resolution function (in a first dimension) is defined as:

$$S ( θ ) = \{ \begin{matrix}{S}_{max} & for \vert θ \vert < {θ}_{f} \\ {S}_{min} + \frac{{S}_{max} - {S}_{min}}{1 + w ( \vert θ - {θ}_{f} \vert )} & for \vert θ \vert \geq {θ}_{f}\end{matrix} ,$$

where Sₘₐₓ is the maximum of the resolution function (e.g., approximately 60 PPD), Sₘᵢₙ is the asymptote of the resolution function, Of characterizes the size of the fovea, and w characterizes a width of the resolution function or how quickly the resolution function falls off outside the fovea as the angle increases from the optical axis.

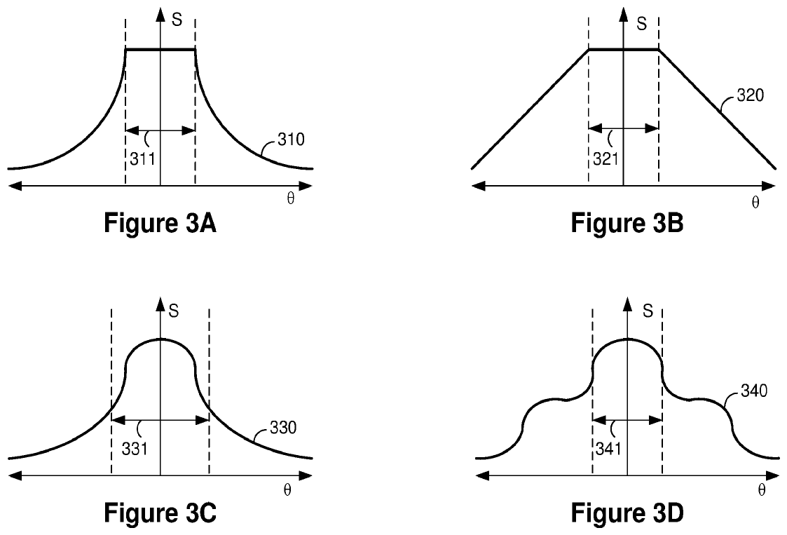

FIG. 3A illustrates a resolution function 310 (in a first dimension) which falls off in an inverse linear fashion from a fovea. FIG. 3B illustrates a resolution function 320 (in a first dimension) which falls off in a linear fashion from a fovea. FIG. 3C illustrates a resolution function 330 (in a first dimension) which is approximately Gaussian. FIG. 3D illustrates a resolution function 340 (in a first dimension) which falls off in a rounded stepwise fashion.

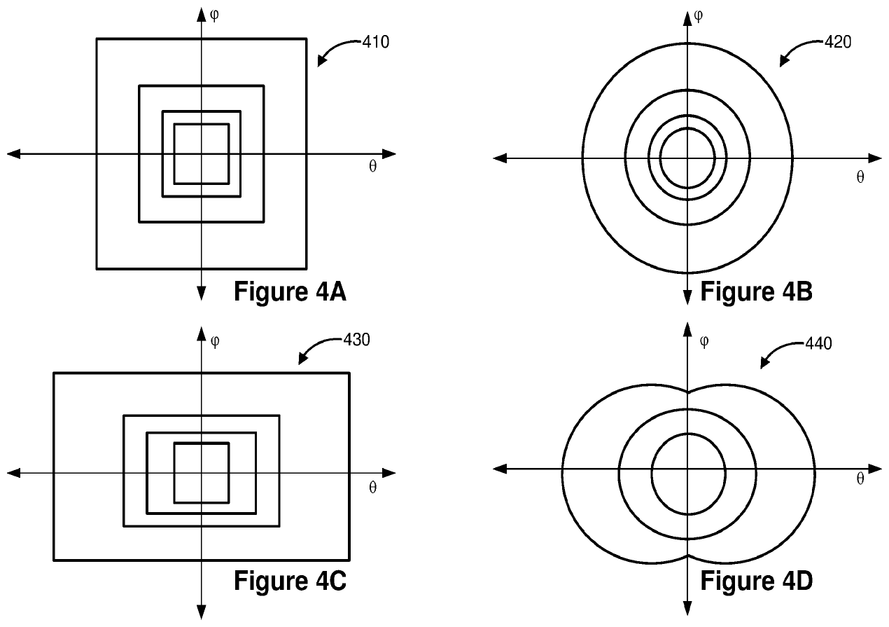

Each of the resolution functions 310-340 of FIGS. 3A-3D is in the form of a peak including a peak height (e.g., a maximum value) and a peak width. The peak width can be defined in a number of ways. In one implementation, the peak width is defined as the size of the fovea (as illustrated by width 311 of FIG. 3A and width 321 of FIG. 3B). In one implementation, the peak width is defined as the full width at half maximum (as illustrated by width 331 of FIG. 3C). In one implementation, the peak width is defined as the distance between the two inflection points nearest the origin (as illustrated by width 341 of FIG. 3D). In various implementations, the number of pixels in a rendered image is proportional to the integral of the resolution function over the field-of-view. Thus, a summation value is defined as the area under the resolution function over the field-of-view.

Whereas FIGS. 3A-3D illustrate resolution functions in a single dimension, it is to be appreciated that the resolution function used by the rendering module 210 can be a two-dimensional function. FIG. 4A illustrates a two-dimensional resolution function 410 in which the resolution function 410 is independent in a horizontal dimension (θ) and a vertical dimension (φ). FIG. 4B illustrates a two-dimensional resolution function 420 in which the resolution function 420 is a function of a single variable (e.g., D=\sqrt{θ²+φ²}). FIG. 4C illustrates a two-dimensional resolution function 430 in which the resolution function 430 is different in a horizontal dimension (θ) and a vertical dimension (φ). FIG. 4D illustrates a two-dimensional resolution function 440 based on a human vision model.

As described in detail below, the rendering module 210 generates the resolution function based on a number of factors, including biological information regarding human vision, eye tracking data, eye tracking metadata, the XR content, and various constraints (such as constraints imposed by the hardware of the electronic device 120).

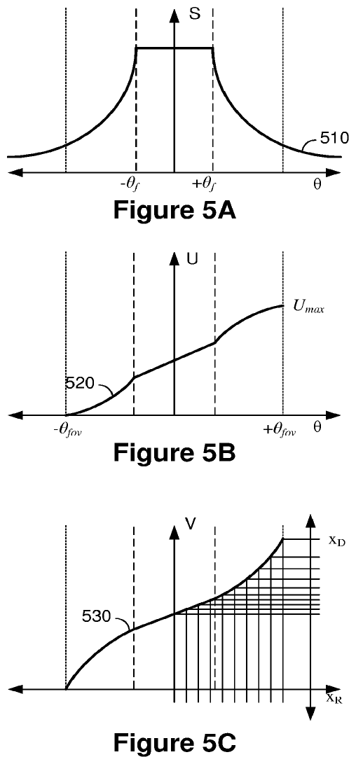

FIG. 5A illustrates an example resolution function 510, denoted S(θ), which characterizes a resolution in the display space as a function of angle in the warped space. The resolution function 510 is a constant (e.g., Sₘₐₓ) within a fovea (between −θ_{f} and +θ_{f}) and falls off in an inverse linear fashion outside this window.

FIG. 5B illustrates the integral 520, denoted U(θ), of the resolution function 510 of FIG. 5A within a field-of-view, e.g., from −θ_{fov} to +θ_{fov}. Thus, U(θ)=∫_{-θ}_{_{fov}}^{θ} S(θ̆)(+)dθ̆. The integral 520 ranges from 0 at −θ_{fov} to a maximum value, denoted Uₘₐₓ, at +θ_{fov}.

FIG. 5C illustrates the tangent 530, denoted V(x_{R}), of the inverse of the integral 520 of the resolution function 510 of FIG. 5A. Thus, V(x_{R})=tan(U⁻¹(x_{R})). The tangent 530 illustrates a direct mapping from rendered space, in x_{R}, to display space, in x_{D}. According to the foveation indicated by the resolution function 510, the uniform sampling points in the warped space (equally spaced along the x_{R} axis) correspond to non-uniform sampling points in the display space (non-equally spaced along the x_{D} axis). Scaling factors can be determined by the distances between the non-uniform sampling points in the display space.

When performing static foveation, the rendering module 210 uses a resolution function that does not depend on the gaze on the user. However, when performing dynamic foveation, the rendering module 210 uses a resolution function that depends on the gaze of the user. In particular, when performing dynamic foveation, the rendering module 210 uses a resolution function that has a peak height at a location corresponding to a location in the display space at which the user is looking (e.g., a gaze point of the user as determined by the eye tracker 260).

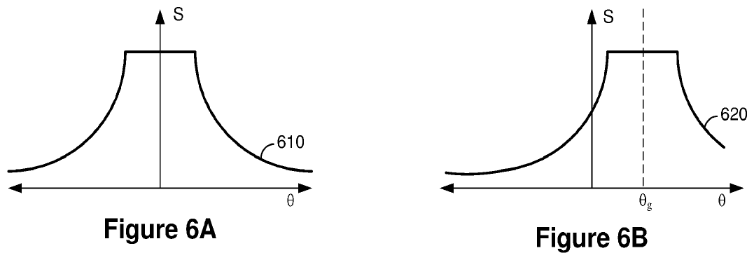

FIG. 6A illustrates a resolution function 610 that may be used by the rendering module 210 when performing static foveation. The rendering module 210 may also use the resolution function 610 of FIG. 6A when performing dynamic foveation and the user is looking at the center of the display panel 240. FIG. 6B illustrates a resolution function 620 that may be used by the rendering module 210 when performing dynamic foveation and the user is looking at a gaze angle (θ_{g}) away from the center of the display panel 240.

Accordingly, in one implementation, the resolution function (in a first dimension) is defined as:

$$S ( θ ) = \{ \begin{matrix}{S}_{max} & for \vert θ - {θ}_{g} \vert < {θ}_{f} \\ {S}_{min} + \frac{{S}_{max} - {S}_{min}}{1 + w ( \vert θ - {θ}_{g} - {θ}_{f} \vert )} & for \vert θ - {θ}_{g} \vert \geq {θ}_{f}\end{matrix} .$$

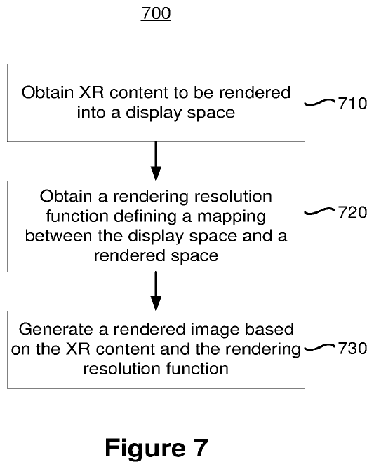

FIG. 7 is a flowchart representation of a method 700 of rendering an image in accordance with some implementations. In some implementations (and as detailed below as an example), the method 700 is performed by a rendering module, such as the rendering module 210 of FIG. 2. In various implementations, the method 700 is performed by an electronic device, such as the electronic device 120 of FIG. 1, or a portion thereof, such as the XR pipeline 200 of FIG. 2. In various implementations, the method 700 is performed by a device with one or more processors, non-transitory memory, and one or more XR displays. In some implementations, the method 700 is performed by processing logic, including hardware, firmware, software, or a combination thereof. In some implementations, the method 700 is performed by a processor executing instructions (e.g., code) stored in a non-transitory computer-readable medium (e.g., a memory).

The method 700 begins, at block 710, with the rendering module obtaining XR content to be rendered into a display space. In various implementations, XR content can include definitions of geometric shapes of virtual objects, colors and/or textures of virtual objects, images (such as a pass-through image of the physical environment), or other information describing content to be represented in the rendered image.

The method 700 continues, at block 720, with the rendering module obtaining a resolution function defining a mapping between the display space and a warped space. Various resolution functions are illustrated in FIGS. 3A-3D and FIGS. 4A-4D. Various methods of generating a resolution function are described further below.

In various implementations, the resolution function generally characterizes the resolution of the rendered image in the display space. Thus, the integral of the resolution function provides a mapping between the display space and the warped space (as illustrated in FIGS. 5A-5C). In one implementation, the resolution function, S(x), is a function of a distance from an origin of the display space. In another implementation, the resolution function, S(θ), is a function of an angle between an optical axis of the user and the optical axis when the user is looking at the center of the display panel. Accordingly, the resolution function characterizes a resolution in the display space as a function of angle (in the display space). Thus, in one implementation, the resolution function, S(θ), is expressed in pixels per degree (PPD).

In various implementations, the rendering module performs dynamic foveation and the resolution function depends on the gaze of the user. Accordingly, in some implementations, obtaining the resolution function includes obtaining eye tracking data indicative of a gaze of a user, e.g., from the eye tracker 260 of FIG. 2, and generating the resolution function based on the eye tracking data. In various implementations, the eye tracking data includes at least one of a data indicative of a gaze angle of the user or data indicative of a gaze point of the user. In particular, in various implementations, generating the resolution function based on the eye tracking data includes generating a resolution function having a peak height at a location the user is looking at as indicated by the eye tracking data.

The method 700 continues, at block 730, with the rendering module generating a rendered image based on the XR content and the resolution function. The rendered image includes a warped image with a plurality of pixels at respective locations uniformly spaced in a grid pattern in the warped space. The plurality of pixels is respectively associated with a plurality of respective pixel values based on the XR content. The plurality of pixels is respectively associated with a plurality of respective scaling factors defining an area in the display space based on the resolution function.

An image that is said to be in a display space has uniformly spaced regions (e.g., pixels or groups of pixels) that map to uniformly spaced regions (e.g., pixels or groups of pixels) of a display. An image that is said to be in a warped space has uniformly spaced regions (e.g., pixels or groups of pixels) that map to non-uniformly spaced regions (e.g., pixels or groups of pixels) in the display space. The relationship between uniformly spaced regions in the warped space to non-uniformly spaced regions in the display space is defined at least in part by the scaling factors. Thus, the plurality of respective scaling factors (like the resolution function) defines a mapping between the warped space and the display space.

In various implementations, the rendering module transmits the warped image including the plurality of pixel values in association with the plurality of respective scaling factors. Accordingly, the warped image and the scaling factors, rather than a foveated image which could be generated using this information, is propagated through the XR pipeline 200.

In particular, with respect to FIG. 2, in various implementations, the rendering module 210 generates a warped image and a plurality of respective scaling factors that are transmitted by the rendering module 210. At various stages in the XR pipeline 200, the warped image (or a processed version of the warped image) and the plurality of respective scaling factors are received (and used in processing the warped image) by the transport module 220 (and the compression module 222 and decompression module 226 thereof). At various stages in the XR pipeline 200, the warped image (or a processed version of the warped image) and the plurality of respective scaling factors are received (and used in processing the warped image) by the display module 230 (and the lens compensation module 232 and the panel compensation module 234 thereof).

In various implementations, the rendering module 210 generates the scaling factors based on the resolution function. For example, in some implementations, the scaling factors are generated based on the resolution function as described above with respect to FIGS. 5A-5C. In various implementations, generating the scaling factors includes determining the integral of the resolution function. In various implementations, generating the scaling factors includes determining the tangent of the inverse of the integral of the resolution function. In various implementations, generating the scaling factors includes, determining, for each of the respective locations uniformly spaced in a grid pattern in the warped space, the respective scaling factors based on the tangent of the inverse of the integral of the resolution function. Accordingly, for a plurality of locations uniformly spaced in the warped space, a plurality of locations non-uniformly spaced in the display space are represented by the scaling factors.

FIG. 8A illustrates an image representation of XR content 810 to be rendered in a display space. FIG. 8B illustrates a warped image 820 generated according to the method 700 of FIG. 7. In accordance with a resolution function, different parts of the XR content 810 corresponding to non-uniformly spaced regions (e.g., different amounts of area) in the display space are rendered into uniformly spaced regions (e.g., the same amount of area) in the warped image 820.

For example, the area at the center of the image representation of XR content 810 of FIG. 8A is represented by an area in the warped image 820 of FIG. 8B including K pixels (and K pixel values). Similarly, the area on the corner of the image representation of XR content 810 of FIG. 8A (a larger area than the area at the center of FIG. 8A) is also represented by an area in the warped image 820 of FIG. 8B including K pixels (and K pixel values).

In various implementations, in order to provide for a three-dimensional XR experience, the display panel 240 includes a first portion for displaying a first displayed image to a first eye of the user 250 (e.g., a left eye of the user 250) and a second portion for simultaneously displaying a second displayed image to a second eye of the user 250 (e.g., a right eye of the user 250). Accordingly, in various implementations, the rendering module 210 renders a first rendered image and a second rendered image based on the XR content. In various implementations, the rendering module 210 renders the first rendered image and the second rendered image using the same resolution function. However, in various implementations, the rendering module 210 renders the first rendered image and the second rendered image using different resolution functions.

For example, in various implementations, the second resolution function has a lower maximum value or a lower summation value than the first resolution function to reduce computation in rendering the first rendered image and the second rendered image while minimally reducing the viewing experience due to binocular suppression. Binocular suppression is a visual phenomenon by which the perceived quality of two simultaneously presented images is not reduced when one of the images is of lesser quality, e.g., the lesser quality of the image is suppressed.

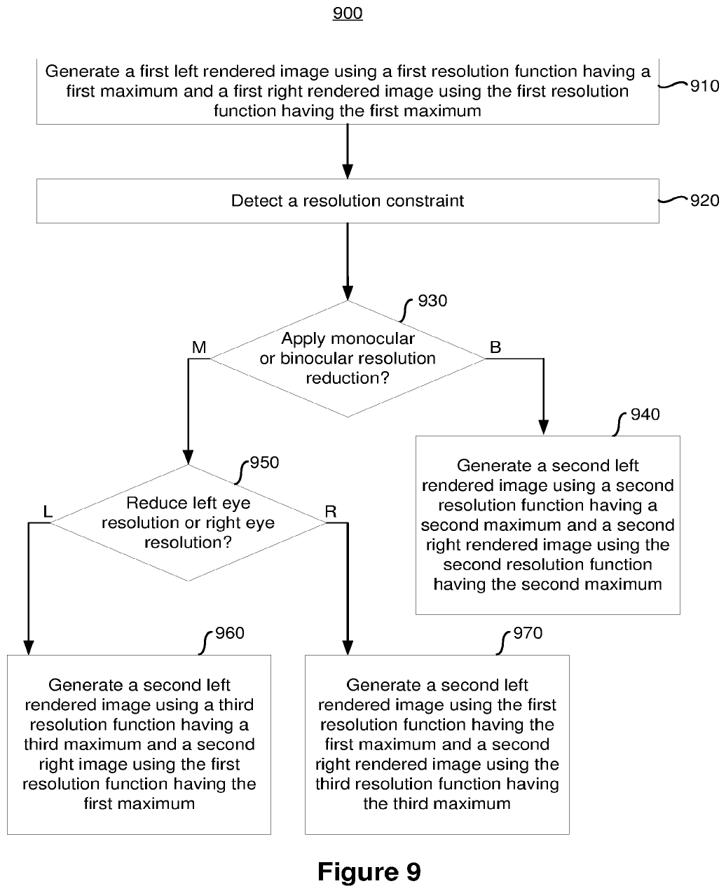

FIG. 9 is a flowchart representation of a method 900 of satisfying a resolution constraint in accordance with some implementations. In some implementations, the method 900 is performed by a rendering module, such as the rendering module 210 of FIG. 2. In various implementations, the method 900 is performed by an electronic device, such as the electronic device 120 of FIG. 1, or a portion thereof, such as the XR pipeline 200 of FIG. 2. In various implementations, the method 900 is performed by a device with one or more processors, non-transitory memory, and one or more XR displays. In some implementations, the method 900 is performed by processing logic, including hardware, firmware, software, or a combination thereof. In some implementations, the method 900 is performed by a processor executing instructions (e.g., code) stored in a non-transitory computer-readable medium (e.g., a memory).

The method 900 begins, at block 910, with the device generating a first left rendered image using a first resolution function having a first maximum and a first right image using the first resolution function having the first maximum. In various implementations, the first left rendered image and the first right rendered image are generated based on first content (e.g., first XR content).

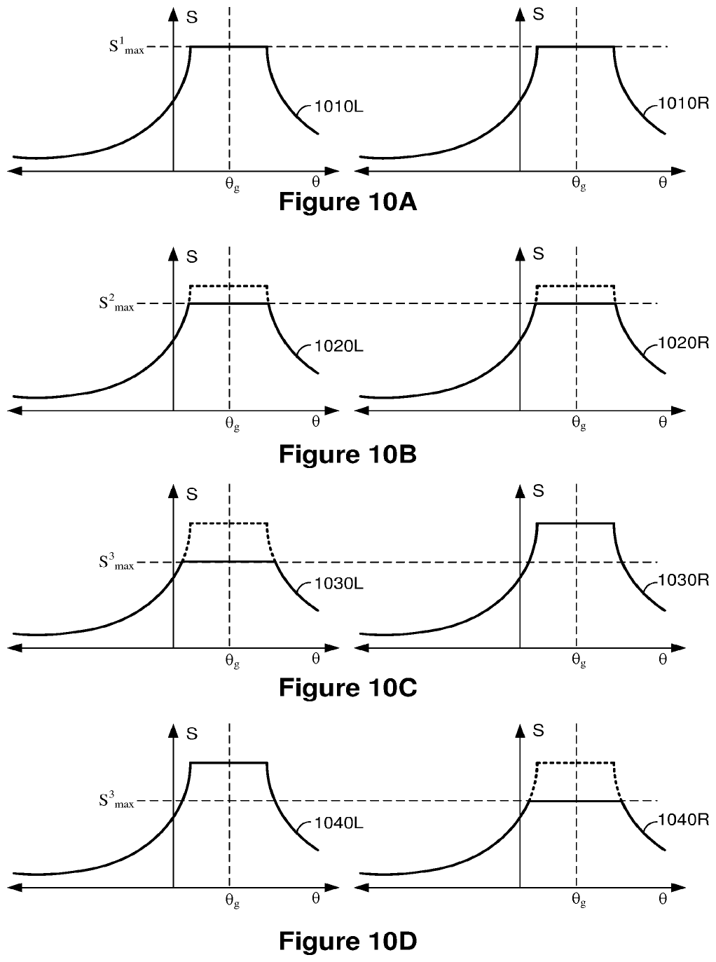

FIG. 10A illustrates an example first resolution function for the first left rendered image 10101, and for the first right rendered image 1010R. The first rendering resolution function has a maximum of S¹ₘₐₓ.

The method 900 continues, in block 920, with the device detecting a resolution constraint. In various implementations, the resolution constraint indicates a number of pixels. In various implementations, the resolution constraint indicates a summation value. In various implementations, the resolution constraint is detected based on a user input. For example, in various implementations, a user activates a low-power mode and, in response, a resolution constraint is generated and/or detected by the device. In various implementations, the resolution constraint is detected based on an amount of available processing power. For example, when the device has a small available processing power (due to a small processing capacity or high usage of the processing capacity), the device may generate and/or detect a resolution constraint. As another example, when a thermal event occurs (e.g., when processing to compute additional pixel values would cause a processor to overheat), the device may generate and/or detect a resolution constraint. In various implementations, the resolution constraint is generated based on a bandwidth of a communications channel. For example, in response to a decrease in signal-to-noise ratio of a communications channel, the device may generate and/or detect a resolution constraint.

The method 900 continues, in block 930, with the device determining whether to apply a monocular resolution reduction or a binocular resolution reduction. In various implementations, the device determines whether to apply the monocular resolution reduction or the binocular resolution reduction based on a user preference. For example, in various implementations, a user may activate or deactivate a setting that allows for monocular resolution reduction. In various implementations, the device determines whether to apply the monocular resolution reduction or the binocular resolution reduction based on the content used to generate the rendered images. For example, in various implementations, when the content is three-dimensional content, the device determines that the device is to apply monocular resolution reduction and when the content is text or video, the device determines that the device is to apply binocular resolution reduction.

If the device determines that the device is to apply binocular resolution reduction, the method 900 continues, in block 940, with the device generating a second left rendered image using a second resolution function having a second maximum and a second right rendered image using the second resolution function having the second maximum. In various implementations, the second maximum is determined such that the summation value of the second resolution function, doubled, satisfies the resolution constraint. In various implementations, the second left rendered image and the second right rendered image are generated based on second content (e.g., second XR content).

FIG. 10B illustrates an example second resolution function for the second left rendered image 1020L and for the second right rendered image 1020R. The second resolution function has a maximum of S²ₘₐₓ, which is less than the maximum of the first resolution function, S¹ₘₐₓ. In various implementations, the second resolution function is a capped version of the first resolution function in which the second resolution function is, at each angle, equal to lesser of the first resolution function at the angle and the second maximum.

If the device determines that the device is to apply monocular resolution reduction, the method 900 continues, in block 950, with the device further determining whether to reduce the resolution of the left eye or the right eye. In various implementations, the device determines whether to reduce the resolution of the left eye or the right eye based on a user preference. For example, a user may explicitly select the left eye or the right eye for resolution reduction via a user interface. As another example, a user may select the left eye or the right eye for resolution reduction via a calibration procedure. In various implementations, the device determines whether to reduce the resolution of the left eye or the right eye based on a variable that alternates between sessions. For example, in various implementations, whether the left eye or the right eye is selected for resolution reduction alternates between each session in which a user puts on, uses, and takes off the device. In various implementations, the device determines whether to reduce the resolution of the left eye or the right eye based on the content used to generate the rendered images. For example, if a user is so positioned such that the left eye's view is looking out a window but the right eye's view is occluded by a wall, the device may determine that the device is to reduce the resolution of the eye viewing low-contrast content (e.g., the right eye viewing the wall). As another example, if a user is looking through a monocular with the left eye, the device may determine that the device is to reduce the resolution of the right eye (which may be presumed to be closed or have its vision suppressed by attention paid to the content viewed through the monocular).

If the device determines that the device is to reduce the resolution of the left eye, the method 900 continues, in block 960, with the device generating a second left rendered image using a third resolution function having a third maximum and a second right image using the first resolution function having the first maximum. In various implementations, the third maximum is determined such that the sum of the summation value of the first resolution function and the summation value of the third resolution function satisfies the resolution constraint.

FIG. 10C illustrates an example third resolution function for the second left rendered image 1030L and the example first resolution function for the second right rendered image 1030R. The third resolution function has a maximum of S³ₘₐₓ, which is less than the maximum of the first rendering function, S¹ₘₐₓ (and less than the maximum of the second resolution function, S²ₘₐₓ). In various implementations, the third resolution function is a capped version of the first resolution function in which the third resolution function is, at each angle, equal to lesser of the first resolution function at the angle and the third maximum.

If the device determines that the device is to reduce the resolution of the right eye, the method 900 continues, in block 970, with the device generating a second left rendered image using the first resolution function having the first maximum and a second right image using the third resolution function having the third maximum.

FIG. 10D illustrates the example first resolution function for the second left rendered image 1040L and the example third resolution function for the second right rendered image 1040R.

Whereas FIG. 9 describes a method in which two different resolution functions are used to generate rendered images to be simultaneously presented (after transformation into respective displayed images) to the two eyes of a user in order to satisfy a resolution constraint, various implementations generate rendered images to be simultaneously presented (after transformation into respective displayed images) to the two eyes of the user for various other reasons. For example, if the vision in one eye is poorer than the vision in the other eye, the resolution function used to generate images for that eye may have a lower maximum than the resolution function used to generate images for the other eye. As another example, if the eyepiece positioned in front of one eye is of lesser quality than the eyepiece positioned in front of the other eye, the resolution function used to generate images for that eye may have a lower maximum than the resolution function used to generate images for the other eye. As another example, if the eye tracking performed for one eye is less accurate than the eye tracking performed for the other eye, the resolution function used to generate images for that eye may have a lower maximum (and/or greater width) than the resolution function used to generate images for the other eye.

Further, whereas FIG. 9 describes a method in which two different resolution functions are used to generate rendered images to be simultaneously presented, various implementations, rendered images to be simultaneously presented are generated to meet different perception criteria. For example, in various implementations, an anti-aliasing algorithm applied to an image for one eye is more computationally intensive than that applied (if one is applied at all) to an image for the other eye. As another example, in various implementations, a blurring algorithm (e.g., for depth effects) applied to an image for one eye is stronger than that applied (if one is applied at all) to an image for the other eye.

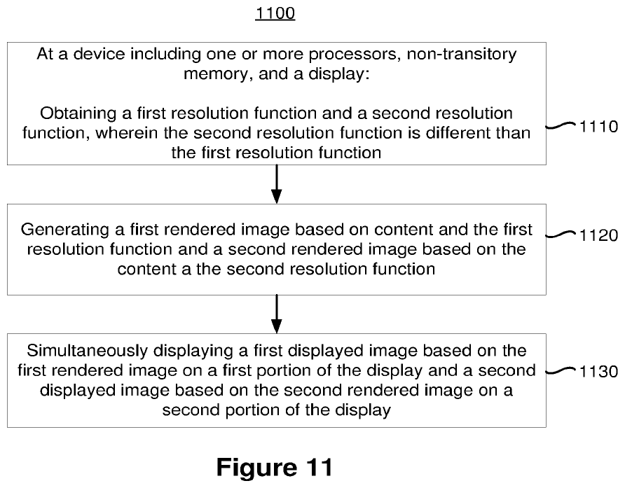

FIG. 11 is a flowchart representation of a method 1100 of rendering images with different resolution functions in accordance with some implementations. In some implementations, the method 1100 is performed by a rendering module, such as the rendering module 210 of FIG. 2. In various implementations, the method 1100 is performed by an electronic device, such as the electronic device 120 of FIG. 1, or a portion thereof, such as the XR pipeline 200 of FIG. 2. In various implementations, the method 1100 is performed by a device with one or more processors, non-transitory memory, and a display. In some implementations, the method 1100 is performed by processing logic, including hardware, firmware, software, or a combination thereof. In some implementations, the method 1100 is performed by a processor executing instructions (e.g., code) stored in a non-transitory computer-readable medium (e.g., a memory).

The method 1100 begins, in block 1110, with the device obtaining a first resolution function and a second resolution function, wherein the second resolution function is different than the first resolution function. In various implementations, a maximum of the second resolution function is different than a maximum of the first resolution function. For example, in FIG. 10D, the maximum of the third resolution function for the right eye 1040R, e.g., S³ₘₐₓ, is less than the maximum of the first resolution function for the left eye 1040L, e.g., S¹ₘₐₓ. In various implementations, a summation value of the second resolution function is different than a summation value of first resolution function. For example, in FIG. 10D, the summation value of the third resolution function for the right eye 1040R is less than the summation value of the first resolution function for the left eye 1040L. In various implementations, the second resolution function is, at each angle, equal to the lesser of the first resolution function at the angle and a maximum of the second resolution function. For example, in FIG. 10D, the third resolution function is a capped version of the first resolution function.

In various implementations, obtaining the first resolution function and the second resolution function includes generating the first resolution function based on a formula with a set of variables having a first set of values and generating the second resolution function based on the formula with the set of variables having a second set of values. In various the formula (in a first dimension) is:

$$S ( θ ) = \{ \begin{matrix}{S}_{max} & for \vert θ - {θ}_{g} \vert < {θ}_{f} \\ {S}_{min} + \frac{{S}_{max} - {S}_{min}}{1 + w ( \vert θ - {θ}_{g} - {θ}_{f} \vert )} & for \vert θ - {θ}_{g} \vert \geq {θ}_{f}\end{matrix} .$$

Thus, in various implementations, the set of values includes a maximum (Sₘₐₓ), an asymptote (Sₘᵢₙ), a first width (θ_{f}), a second width (w), and a gaze angle (θ_{g}). In various implementations, the set of variables includes at least one of a maximum, a minimum, an asymptote, a width, or a gaze angle. In various implementations, the second set of values differs from the first set of values by having a different maximum. For example, in FIG. 10D, the maximum of the third resolution function for the right eye 1040R, e.g., S³ₘₐₓ, is less than the maximum of the first resolution function for the left eye 1040L, e.g., S¹ₘₐₓ. In various implementations, the second set of values differs from the first set of values by having a different width. For example, in FIG. 10D, the width of the third resolution function for the right eye 1040R is greater than the width of the first resolution function for the left eye 1040L. In various implementations, at least one of the first set of values is the same as at least one of the second set of values. For example, in FIG. 10D, the gaze angle of the third resolution function for the right eye 1040R is the same as the gaze angle of the first resolution function for the left eye 1040L.

The method 1100 continues, in block 1120, with the device generating a first rendered image based on content and the first resolution function and a second rendered image based on the content and the second resolution function. In various implementations, the device generates the first rendered image and the second rendered image as described above with respect to FIG. 7.

The method 1100 continues, in block 1130, with the device simultaneously displaying a first displayed image based on the first rendered image on a first portion of the display and a second displayed image based on the second rendered image on a second portion of the display. In various implementations, the first portion of the display is positioned in front of a first eye of a user (e.g., the left eye of the user) and a second portion of the display is positioned in front of a second eye of the user (e.g., the right eye of the user).

In various implementations, the first displayed image and second displayed image are foveated images respectively based on the first rendered image and the second rendered image, which are warped images. Thus, in various implementations, the method 1100 includes transforming the first rendered image and the second rendered image into the first displayed image and the second displayed image based on the first resolution function and the second resolution function (e.g., based on first scaling factors based on the first resolution function and second scaling factors based on the second resolution function).

In various implementations, the method 1100 includes detecting a resolution constraint, wherein a sum of a first summation value of the first resolution function and a second summation value of the second resolution function satisfies the resolution constraint. In various implementations, obtaining the first resolution function and the second resolution function is performed in response to detecting the resolution constraint. In various implementations, obtaining the first resolution function and the second resolution function includes generating the first resolution function and the second resolution function to satisfy the resolution constraint. For example, in FIG. 9, the device detects the resolution constraint in block 920 and obtains different resolution functions in block 960 (or block 970).

In various implementations, the method 1100 includes determining that the device is to perform monocular resolution reduction, wherein obtaining the first resolution function and the second resolution function is performed in response to determining that the device is to perform monocular resolution reduction. For example, in FIG. 9, when the device determines that the device is to perform monocular resolution reduction in block 930, the device obtains different resolution functions in block 960 (or block 970). In various implementations, determining that the device is to perform monocular resolution reduction is based on a user preference. In various implementations, determining that the device is to perform monocular resolution reduction is based on the content.

In various implementations, the method 1100 further includes selecting the first resolution function or the second resolution function as having a lower summation value, wherein obtaining the first resolution function and the second resolution function is performed in response to selecting the first resolution function or the second resolution function as having a lower summation value and wherein the selected one of the first resolution function or the second resolution function has the lower summation value. For example, in FIG. 9, the device selects whether to reduce the resolution of the left eye or the right eye in block 950 and obtains different resolution functions in block 960 (or block 970). In various implementations, selecting the first resolution function or the second resolution function is based on a user preference. In various implementations, selecting the first resolution function or the second resolution function is based on the content. In various implementations, selecting the first resolution function or the second resolution function is based on a variable that alternates between sessions.

In various implementations, in addition to generating stereoscopic images based on different resolution functions, the method 1100 includes generating stereoscopic images based on the same resolution function. For example, in FIG. 10A, the first resolution function for the left eye 1010L is the same as the first resolution function for the right eye 1010R. As another example, in FIG. 10B, the second resolution function for the left eye 1020L is the same as the second resolution function for the right eye 1020R. Thus, in various implementations, the method 1110 includes generating a third rendered image based on the content and a third resolution function and a fourth rendered image based on the content and the third resolution function. The method 1110 includes simultaneously displaying a third displayed image based on the third rendered image on the first portion of the display and a fourth displayed image based on the fourth rendered image on the second portion of the display. In various implementations, the third displayed image and fourth displayed image are displayed before the first displayed image and the second displayed image. For example, the third displayed image and the fourth displayed image may correspond to the first left rendered image and the first right rendered image of block 910 in FIG. 9 and, thus, may be displayed before a resolution constraint is detected. In various implementations, the third displayed image and the second displayed image are displayed after the first displayed image and the second displayed image, e.g., which a resolution constraint is lifted. In various implementations, the third displayed image and the second displayed image may correspond to the second left rendered image and the second right rendered image of block 940 in FIG. 9 and may be displayed before or after the first displayed image or the second displayed image.

Whereas FIG. 11 describes a method in which two rendered images to be simultaneously presented have different resolutions, in various implementations, the method includes generating two rendered images to be simultaneously presented having different perception quality, such as resolution, color gamut, aliasing, frame rate, etc.

FIG. 12 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 1202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 1206, one or more communication interfaces 1208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 1210, a memory 1220, and one or more communication buses 1204 for interconnecting these and various other components.

In some implementations, the one or more communication buses 1204 include circuitry that interconnects and controls communications between system components. In some implementations, the one or more I/O devices 1206 include at least one of a keyboard, a mouse, a touchpad, a joystick, one or more microphones, one or more speakers, one or more image sensors, one or more displays, and/or the like.

The memory 1220 includes high-speed random-access memory, such as dynamic random-access memory (DRAM), static random-access memory (SRAM), double-data-rate random-access memory (DDR RAM), or other random-access solid-state memory devices. In some implementations, the memory 1220 includes non-volatile memory, such as one or more magnetic disk storage devices, optical disk storage devices, flash memory devices, or other non-volatile solid-state storage devices. The memory 1220 optionally includes one or more storage devices remotely located from the one or more processing units 1202. The memory 1220 comprises a non-transitory computer readable storage medium. In some implementations, the memory 1220 or the non-transitory computer readable storage medium of the memory 1220 stores the following programs, modules and data structures, or a subset thereof including an optional operating system 1230 and an XR experience module 1240.

The operating system 1230 includes procedures for handling various basic system services and for performing hardware dependent tasks. In some implementations, the XR experience module 1240 is configured to manage and coordinate one or more XR experiences for one or more users (e.g., a single XR experience for one or more users, or multiple XR experiences for respective groups of one or more users). To that end, in various implementations, the XR experience module 1240 includes a data obtaining unit 1242, a tracking unit 1244, a coordination unit 1246, and a data transmitting unit 1248.

In some implementations, the data obtaining unit 1242 is configured to obtain data (e.g., presentation data, interaction data, sensor data, location data, etc.) from at least the electronic device 120 of FIG. 1. To that end, in various implementations, the data obtaining unit 1242 includes instructions and/or logic therefor, and heuristics and metadata therefor.

In some implementations, the tracking unit 1244 is configured to map the physical environment 105 and to track the position/location of at least the electronic device 120 with respect to the physical environment 105 of FIG. 1. To that end, in various implementations, the tracking unit 1244 includes instructions and/or logic therefor, and heuristics and metadata therefor.

In some implementations, the coordination unit 1246 is configured to manage and coordinate the XR experience presented to the user by the electronic device 120. To that end, in various implementations, the coordination unit 1246 includes instructions and/or logic therefor, and heuristics and metadata therefor.

In some implementations, the data transmitting unit 1248 is configured to transmit data (e.g., presentation data, location data, etc.) to at least the electronic device 120. To that end, in various implementations, the data transmitting unit 1248 includes instructions and/or logic therefor, and heuristics and metadata therefor.

Although the data obtaining unit 1242, the tracking unit 1244, the coordination unit 1246, and the data transmitting unit 1248 are shown as residing on a single device (e.g., the controller 110), it should be understood that in other implementations, any combination of the data obtaining unit 1242, the tracking unit 1244, the coordination unit 1246, and the data transmitting unit 1248 may be located in separate computing devices.

Moreover, FIG. 12 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 12 could be implemented in a single module and the various functions of single functional blocks could be implemented by one or more functional blocks in various implementations. The actual number of modules and the division of particular functions and how features are allocated among them will vary from onc implementation to another and, in some implementations, depends in part on the particular combination of hardware, software, and/or firmware chosen for a particular implementation.

FIG. 13 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 1302 (e.g., microprocessors, ASICs, FPGAs, GPUs, CPUs, processing cores, and/or the like), one or more input/output (I/O) devices and sensors 1306, one or more communication interfaces 1308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 1310, one or more XR displays 1312, one or more optional interior- and/or exterior-facing image sensors 1314, a memory 1320, and one or more communication buses 1304 for interconnecting these and various other components.

In some implementations, the one or more communication buses 1304 include circuitry that interconnects and controls communications between system components. In some implementations, the one or more I/O devices and sensors 1306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 1312 are configured to provide the XR experience to the user. In some implementations, the one or more XR displays 1312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 1312 correspond to diffractive, reflective, polarized, holographic, etc. waveguide displays. For example, the electronic device 120 includes a single XR display. In another example, the electronic device includes an XR display for each eye of the user. In some implementations, the one or more XR displays 1312 are capable of presenting MR and VR content.

In some implementations, the one or more image sensors 1314 are configured to obtain image data that corresponds to at least a portion of the face of the user that includes the eyes of the user (any may be referred to as an eye-tracking camera). In some implementations, the one or more image sensors 1314 are configured to be forward-facing so as to obtain image data that corresponds to the physical environment as would be viewed by the user if the electronic device 120 was not present (and may be referred to as a scene camera). The one or more optional image sensors 1314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 1320 includes high-speed random-access memory, such as DRAM, SRAM, DDR RAM, or other random-access solid-state memory devices. In some implementations, the memory 1320 includes non-volatile memory, such as one or more magnetic disk storage devices, optical disk storage devices, flash memory devices, or other non-volatile solid-state storage devices. The memory 1320 optionally includes one or more storage devices remotely located from the one or more processing units 1302. The memory 1320 comprises a non-transitory computer readable storage medium. In some implementations, the memory 1320 or the non-transitory computer readable storage medium of the memory 1320 stores the following programs, modules and data structures, or a subset thereof including an optional operating system 1330 and an XR presentation module 1340.

The operating system 1330 includes procedures for handling various basic system services and for performing hardware dependent tasks. In some implementations, the XR presentation module 1340 is configured to present XR content to the user via the one or more XR displays 1312. To that end, in various implementations, the XR presentation module 1340 includes a data obtaining unit 1342, a resolution function generating unit 1344, an XR presenting unit 1346, and a data transmitting unit 1348.

In some implementations, the data obtaining unit 1342 is configured to obtain data (e.g., presentation data, interaction data, sensor data, location data, etc.) from at least the controller 110 of FIG. 1. To that end, in various implementations, the data obtaining unit 1342 includes instructions and/or logic therefor, and heuristics and metadata therefor.

In some implementations, the resolution function generating unit 1344 is configured to generate different resolution functions for rendering images for different eyes of a user. To that end, in various implementations, the resolution function generating unit 1344 includes instructions and/or logic therefor, and heuristics and metadata therefor.

In some implementations, the XR presenting unit 1346 is configured to display the transformed image via the one or more XR displays 1312. To that end, in various implementations, the XR presenting unit 1346 includes instructions and/or logic therefor, and heuristics and metadata therefor.

In some implementations, the data transmitting unit 1348 is configured to transmit data (e.g., presentation data, location data, etc.) to at least the controller 110. In some implementations, the data transmitting unit 1348 is configured to transmit authentication credentials to the electronic device. To that end, in various implementations, the data transmitting unit 1348 includes instructions and/or logic therefor, and heuristics and metadata therefor.

Although the data obtaining unit 1342, the resolution function generating unit 1344, the XR presenting unit 1346, and the data transmitting unit 1348 are shown as residing on a single device (e.g., the electronic device 120), it should be understood that in other implementations, any combination of the data obtaining unit 1342, the resolution function generating unit 1344, the XR presenting unit 1346, and the data transmitting unit 1348 may be located in separate computing devices.

Moreover, FIG. 13 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 13 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device including one or more processors, non-transitory memory, and a display:
obtaining a first resolution function and a second resolution function, wherein the second resolution function is different than the first resolution function;
generating a first rendered image based on content and the first resolution function and a second rendered image based on the content and the second resolution function; and
simultaneously displaying a first displayed image based on the first rendered image on a first portion of the display and a second displayed image based on the second rendered image on a second portion of the display.

2. The method of claim 1, wherein a maximum of the second resolution function is different than a maximum of the first resolution function.

3. The method of claim 1, wherein a summation value of the second resolution function is different than a summation value of the first resolution function.

4. The method of claim 1, wherein the second resolution function is, at each angle, equal to the lesser of the first resolution function at the angle and a maximum of the second resolution function.

5. The method of claim 1, wherein obtaining the first resolution function and the second resolution function includes:
generating the first resolution function based on a formula with a set of variables having a first set of values; and
generating the second resolution function based on the formula with the set of variables having a second set of values.

6. The method of claim 1, wherein the first portion of the display is positioned in front of a first eye of a user and a second portion of the display is positioned in front of a second eye of the user.

7. The method of claim 1, further comprising detecting a resolution constraint, wherein a sum of a first summation value of the first resolution function and a second summation value of the second resolution function satisfies the resolution constraint.

8. The method of claim 7, wherein obtaining the first resolution function and the second resolution function is performed in response to detecting the resolution constraint.

9. The method of claim 1, further comprising determining that the device is to perform monocular resolution reduction, wherein obtaining the first resolution function and the second resolution function is performed in response to determining that the device is to perform monocular resolution reduction.

10. The method of claim 9, wherein determining that the device is to perform monocular resolution reduction is based on a user preference.

11. The method of claim 9, wherein determining that the device is to perform monocular resolution reduction is based on the content.

12. The method of claim 1, further comprising selecting the first resolution function or the second resolution function as having a lower summation value, wherein obtaining the first resolution function and the second resolution function is performed in response to selecting the first resolution function or the second resolution function as having a lower summation value and wherein the selected one of the first resolution function or the second resolution function has the lower summation value.

13. The method of claim 12, wherein selecting the first resolution function or the second resolution function is based on a user preference.

14. The method of claim 12, wherein selecting the first resolution function or the second resolution function is based on the content.

15. The method of claim 12, wherein selecting the first resolution function or the second resolution function is based on a variable that alternates between sessions.

16. The method of claim 1, further comprising:
generating a third rendered image based on the content and a third resolution function and a fourth rendered image based on the content and the third resolution function; and
simultaneously displaying a third displayed image based on the third rendered image on the first portion of the display and a fourth displayed image based on the fourth rendered image on the second portion of the display.

17. A device comprising:
a display;
a non-transitory memory; and
one or more processors to:
obtain a first resolution function and a second resolution function, wherein the second resolution function is different than the first resolution function;
generate a first rendered image based on content and the first resolution function and a second rendered image based on the content and the second resolution function; and
simultaneously display a first displayed image based on the first rendered image on a first portion of the display and a second displayed image based on the second rendered image on a second portion of the display.

18. The device of claim 17, wherein a maximum of the second resolution function is different than a maximum of the first resolution function.

19. The device of claim 17, wherein a summation value of the second resolution function is different than a summation value of the first resolution function.

20. A non-transitory memory storing one or more programs, which, when executed by one or more processors of a device including a display, cause the device to:
obtain a first resolution function and a second resolution function, wherein the second resolution function is different than the first resolution function;
generate a first rendered image based on content and the first resolution function and a second rendered image based on the content and the second resolution function; and
simultaneously display a first displayed image based on the first rendered image on a first portion of the display and a second displayed image based on the second rendered image on a second portion of the display.
